(19) United States
(12) Patent Application Publication
(10) Pub. No.: US 2008/0044583 A1
(43) Pub. Date: Feb. 21, 2008

(54) Device for applying a coating medium to an elongate workpiece, comprising a guiding device

(76) Inventor: Stefan Schiele, Niederzissen (DE)

Correspondence Address: Friedrich Kueffner, Suite 910, 317 Madison Avenue, New York, NY, 10017, US

(21) Appl. No.: 11/807,358

(22) Filed: May 25, 2007

Related U.S. Application Data
(63) Continuation of application No. PCT/EP05/56183, filed on Nov. 24, 2005.

(30) Foreign Application Priority Data
Nov. 26, 2004 (DE) 10 2004 057 299.2

(51) Int. Cl. B05B 13/02

(52) U.S. Cl. 427/424; 118/305; 118/50

(57) ABSTRACT

A device for applying a coating medium to at least partial surfaces of an elongate workpiece which is transported in a longitudinal direction thereof includes a coating device and a guiding device, wherein the coating device and/or the guiding device are adaptable to the workpiece, and wherein the coating device and/or the guiding device change the form of the workpiece.

### CROSS-REFERENCE TO RELATED APPLICATIONS

This application is a continuation application of International Application PCT/EP05/056183, filed Nov. 24, 2005.

### BACKGROUND OF THE INVENTION

1. Field of the Invention

The present invention relates to a device for applying a coating medium to at least partial surfaces of an elongate workpiece which is transported in its longitudinal direction, comprising a coating device and a guiding device, and relates to a method for coating elongate workpieces which are transported in their longitudinal direction, by means of a guiding device.

2. Description of the Related Art

It is known to provide elongate workpieces which are transported in their longitudinal direction with a coating medium, at least on part of their surface. Such a device is known for example from WO 02/055214 A1. This device has a coating frame, which is formed as a flat nozzle and is arranged between the outlet guide and the outlet matrix.

### SUMMARY OF THE INVENTION

On the basis of this prior art, a person skilled in the art is faced with the object of providing a device for applying a coating medium with which the workpiece can be coated over its full circumference and with which the starting situation encountered in the production of a new workpiece can be handled.

The object is achieved by a device for applying a coating medium in which the coating device and/or the guiding device change the shape of the workpiece, preferably reversible.

Liquids that can be pumped and filtered and can be passed through nozzles, such as pigment solutions, paints, lacquers, primers, dispersions, emulsions, oils and impregnating agents and/or adhesives are used for example as the coating medium. The coating media often include a solvent, preferably water.

For the purposes of the invention, an elongate workpiece is any workpiece of which the longitudinal axis is greater than its transverse axis and which is to be coated. The material of the workpiece may be, for example, wood, metal, plastic, such as for example EPDM, ABS, PP, PVC or a composite or a mixture of these materials. The workpiece has preferably been produced by a shaping method, such as for example extrusion, or a machining method before coating.

According to the invention, the guiding device has a contour, preferably a tapering, which is adaptable to the profile contour of the workpiece. With the guiding device, the desired position of the workpiece, for example in relation to the coating device, is fixed. The guiding device preferably encloses the profile contour of the workpiece at least to such an extent that the latter is fixed in its position in a plane which is substantially at right angles to the running direction. With respect to the running direction of the workpiece, the guiding device is preferably located in front of the coating device or inside it. The guiding device is preferably produced or set in such a way that it completely encloses the contour of the profile, a small gap being present between the guiding device and the workpiece and preferably being 0.1-1 mm.

According to the invention, the device has a coating device, with which the coating medium is applied to the workpiece to be coated. The coating device is preferably a nozzle, which applies the coating medium to the workpiece. For the coating operation, the workpiece is moved along the coating device. The coating device preferably coats the workpiece simultaneously over its full circumference. It is also preferred for a number of workpieces to be coated simultaneously, preferably over their full circumference. This preferred embodiment of the present invention allows the production capacity of a production line to be increased.

It is possible by means of the device according to the invention to cope with different production phases in a production process, without for example having to bypass the coating device and/or the guiding device. For example, in the case of an extrusion process, the extruded workpiece has initially, i.e. when starting with a new batch, a different cross section than in the further course of the production process. In order to cope with this situation, it is advantageous that the coating device and/or the guiding device of the device according to the invention is adaptable to the contour of the workpiece to be produced.

The coating device and/or the guiding device is for example of a one-part configuration, preferably a multi-part configuration and with most particular preference a two-part configuration. This embodiment of the present invention has the advantage that the parts of the coating device and/or of the guiding device, preferably two parts, are arranged for example such that they can be moved apart and together, and so it is possible to allow for changing cross sections of the profile produced. It is therefore particularly preferred for the coating device and/or the guiding device or parts of the coating device and/or of the guiding device to be displaceably arranged, so that the respective parts of the coating device and/or of the guiding device are preferably movable in the same or different directions. The divided embodiment of the coating device and/or the guiding device additionally has the advantage that a number of workpieces can be coated simultaneously.

The guiding device is preferably conically formed, so that it tapers in the running direction of the workpiece.

In a most particularly preferred embodiment, the coating device and/or the guiding device is designed such that it changes the form of the workpiece, preferably reversibly. This embodiment is suitable in particular in the case of elastic materials, such as some common plastics, and makes it possible for example to coat undercuts, for example by the undercuts being bent open and coated by the coating device and/or the guiding device and then springing back into their original form.

In a most particularly preferred embodiment of the present invention, the guiding device and the coating device are integrated in one component.

The coating device, preferably also the guiding device, is arranged in an application chamber. It is particularly preferred for the application chamber to have an inlet matrix and an outlet matrix, which are respectively arranged with respect to the transporting direction of the workpiece in front of and behind the coating device and preferably also the guiding device. A vacuum can preferably be applied to the application chamber. It is further preferred for the connections for the coating medium to be arranged inside the application chamber. The temperature of the chamber is preferably variable with respect to the ambient temperature; it is particularly preferred for the chamber to be heatable or coolable.

The present invention also relates to a method for coating elongate workpieces which are transported in their longitudinal direction by means of a coating device and/or guiding device, in which the coating device and/or the guiding device is adapted to the workpiece.

With respect to the coating device and/or the guiding device, reference is made to the disclosure made above.

The coating device and/or the guiding device is preferably displaceably arranged and is displaced before and/or during the coating.

It is further preferred for the workpiece to be coated over its full circumference.

The present invention also relates to a method for coating elongate workpieces which are transported in their longitudinal direction by means of a coating device and/or guiding device, in which the coating device and/or the guiding device changes the workpiece in its form, preferably substantially reversibly.

The device according to the invention and the methods according to the invention have the advantage that:
the coating device and/or the guiding device are adaptable to the profile of the workpiece to be coated,
the coating device and/or the guiding device are laterally displaceable,
the coating device and/or the guiding device operate simultaneously on all sides of the workpiece,
the guiding device supports the original form of the workpiece,
the coating device and/or the guiding device opens up the workpiece in order to permit coating in areas that are not easily accessible,
the supply of material takes place entirely outside the application chamber.

The invention is explained below on the basis of FIGS. 1-3. These explanations are merely given by way of example and do not restrict the general concept of the invention. The explanations apply equally to the device according to the invention and to the methods according to the invention.

The various features of novelty which characterize the invention are pointed out with particularity in the claims annexed to and forming a part of the disclosure. For a better understanding of the invention, its operating advantages, specific objects attained by its use, reference should be had to the drawing and descriptive matter in which there are illustrated and described preferred embodiments of the invention.

### BRIEF DESCRIPTION OF THE DRAWING

In the drawing:

FIG. 1 shows the device according to the invention in an application chamber.

FIG. 2 shows the device according to the invention, in which the guiding device and the coating device are divided in two.

FIG. 3 shows the device according to FIG. 2 in use.

### DESCRIPTION OF THE PREFERRED EMBODIMENTS

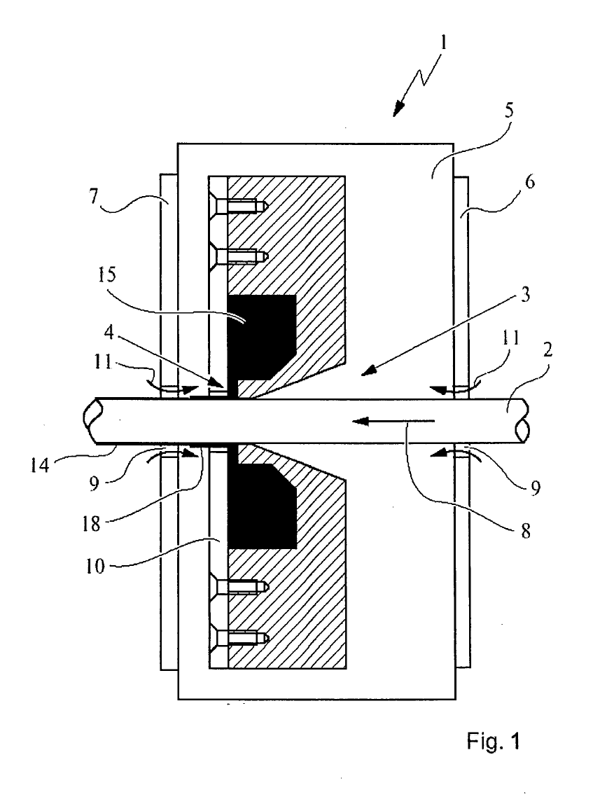

Of a device 1 for applying a coating medium to at least a partial surface, but in the present case to the entire surface, of an elongate workpiece 2, which is transported in its longitudinal direction according to the arrow 8, FIG. 1 shows the coating chamber 5, which is connected to a vacuum line (not represented). This coating chamber 5 has an inlet matrix 6 and an outlet matrix 7, the cross section of which corresponds to the cross section of the workpiece 2, the cross section of the matrices being slightly larger however, so that a gap 9 of a predetermined size is obtained. On account of the vacuum in the application chamber 5, air is sucked in from the outside via the gap. In the coating chamber 5 there is at a distance from the inlet matrix 6 and the outlet matrix 7 a guiding device 4, which ensures positionally exact transport of the workpiece. The guiding device is conically configured; i.e. its cross section tapers from right to left. In the region on the left, the contour of the cross section of the guiding device corresponds to the contour of the cross section of the workpiece, but is slightly larger, so that a gap of about 0.5 mm is obtained between the guiding device and the workpiece. As further explained later, the contour of the guiding device and/or of the coating device does not have to correspond to the original contour of the workpiece, because the contour of the workpiece can be reversibly changed with the coating device and/or the guiding device. In this guiding device 3 there is a channel 15, which is charged with the coating medium 18, for example paint or adhesive, via a line not represented in this figure. Leading outward from this channel 15 to the workpiece 2 is a so-called flat nozzle 3, which is formed by the channel and the cover plate 10. By means of this flat nozzle 4, the coating medium is then sprayed onto the entire circumference of the elongate workpiece 2. The fact that, with respect to the transporting direction of the workpiece, the application of the coating medium takes place behind the guiding device means that the coating of the guiding device is not damaged. The air sucked in via the gap 9 has the effect that excess coating medium is entrained by the air stream and, as a result, is removed from the workpiece 2 and/or better distributed on it. The entrained coating medium is separated from the air stream in a device not represented and recycled into the coating process.

While in the case of the exemplary embodiment represented and described the coating device 3 configured as a flat nozzle is integrated in the guiding device, these two devices may also be separately arranged.

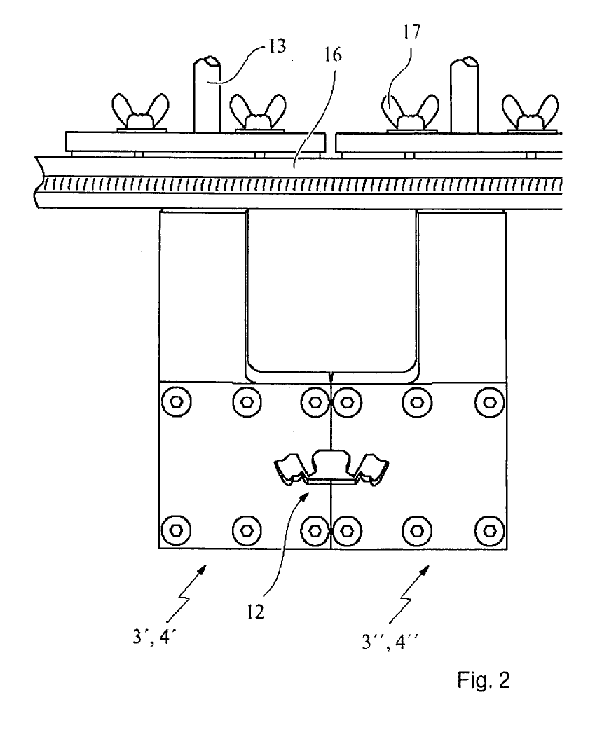

FIG. 2 shows an embodiment of the coating device 3 and the guiding device 4 which in the present case, as represented in FIG. 1, are integrated in each other. It can be clearly seen that the coating device 3 and the guiding device 4 are of a two-part configuration. The two parts 3′, 3″ and 4′, 4″ are configured mirror-symmetrically and mounted displaceably along a guide, which in the present case is configured as a rail. The two parts can be moved in any desired directions along the rail.

For example, they can be moved away from each other, for the case where the workpiece is not to be coated. For coating, the halves can be pushed together again and the workpiece is preferably thereby threaded in, the coating preferably only beginning when the workpiece has been threaded in. The two halves of the coating device 3 and the guiding device 4 can, however, also be pushed together. In the present case, the contour of the coating device 3 and the guiding device 4 is designed such that two workpieces can be coated simultaneously. Furthermore, the contour of the coating device 3 and the guiding device 4 is designed such that the contour of the workpiece is reversibly changed, so that it can be coated better.

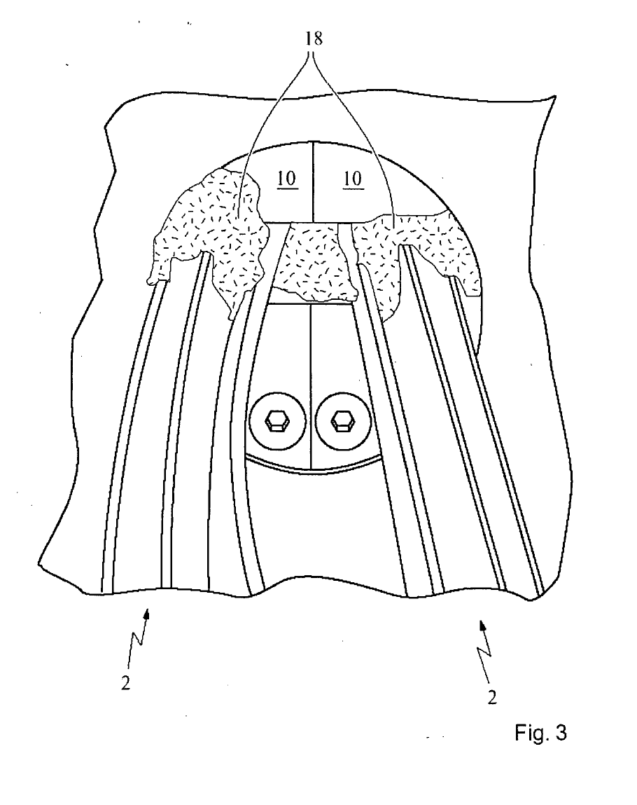

FIG. 3 shows the coating device 3 and the guiding device 4 in use. Two workpieces 3 are made to pass through the cross section of the coating device 3 and the-guiding device 4, the channel within the workpieces being widened by the guiding device 4, so that it can be better coated with coating medium. It is evident that, in this way, the entire outer surface of the workpiece can be coated.

While specific embodiments of the invention have been described in detail to illustrate the inventive principles, it will be understood that the invention may be embodied otherwise without departing from such principles.

We claim:

1. A device for applying a coating medium to at least partial surfaces of an elongate workpiece which is transported in a longitudinal direction thereof, the device comprising a coating device and a guiding device, the coating device and/or the guiding device being adaptable to the workpiece, wherein the coating device and/or the guiding device change the form of the workpiece.

2. The device as claimed in claim 1, wherein the change is reversible.

3. The device as claimed in claim 1, wherein the coating device and/or the guiding device are of a one-part configuration.

4. The device as claimed in claim 1, wherein the coating device and/or the guiding device are of a multi-part configuration.

5. The device as claimed in claim 1, wherein the coating device and/or the guiding device are of a two-part configuration.

6. The device as claimed in claim 1, wherein the coating device and/or the guiding device are displaceabe.

7. The device as claimed in claim 2, wherein the coating device and/or the guiding device are movable in the same or different directions.

8. The device as claimed in claim 1, wherein the coating device is configured to coat the workpiece simultaneously over its full circumference.

9. The device as claimed in claim 1, wherein the guiding device is conically formed.

10. The device as claimed in claim 1, wherein the guiding device and the coating device are one component.

11. The device as claimed in claim 11, wherein at least the coating device is arranged in an application chamber.

12. The device as claimed in claim 1, wherein the guiding device is arranged in an application chamber.

13. The device as claimed in claim 11, wherein the application chamber has an inlet matrix and an outlet matrix, which are respectively arranged with respect to the transporting direction of the workpiece in front of and behind the coating device.

14. The device as claimed in claim 11, wherein the application chamber has an inlet matrix and an outlet matrix, which are respectively arranged with respect to the transporting direction of the workpiece in front of and behind the guiding device.

15. The device as claimed in claim 11, wherein a vacuum is applied to the application chamber.

16. The device as claimed in claim 11, wherein connections for the coating medium are arranged outside the application chamber.

17. The device as claimed in claim 11, wherein the temperature of the chamber is variable with respect to the ambient temperature.

18. The device as claimed in claim 17, wherein the chamber is heatable or coolable.

19. A method for coating elongate workpieces which are transported in their longitudinal direction, using a coating device and a guiding device, the method comprising the coating device and/or the guiding device changing the workpiece in its form by means of the coating device and/or the guiding device.

20. The method according to claim 19, wherein the form is changed substantially reversibly.

21. The method as claimed in claim 20, wherein the coating device and/or the guiding device are adapted to the workpiece.

22. The method as claimed in claim 21, wherein the coating device and/or the guiding device are displaceably arranged and are displaced before and/or during the coating.

23. The method as claimed in claim 19, wherein the workpiece is coated over its full circumference.
